(19) United States
(12) Patent Application Publication
(10) Pub. No.: US 2004/0244786 A1
(43) Pub. Date: Dec. 9, 2004

(54) Balanced storm combustion chamber

(76) Inventor: Abel Van Wyk, West Hill (CA)

Correspondence Address: WALKER & JOCKE, L.P.A., 231 SOUTH BROADWAY STREET, MEDINA, OH, 44256, US

(21) Appl. No.: 10/859,905

(22) Filed: Jun. 2, 2004

(30) Foreign Application Priority Data
Jun. 2, 2003 (CA) CA 2,430,340

(51) Int. Cl. F02B 23/00

(52) U.S. Cl. 123/657

(57) ABSTRACT

This invention relates to making the combustion chambers of internal combustion engines in such a way that during the period of compression, and due to it, and during the combustion period, and due to it, a storm effect will be created in the air and gasses, by which a predictable control over the combustion will result in the fuel burning as completely as possible, making the efficiency of the engine as high as possible; and so that the perpendicular pressures and forces due to the tangential forces of compression and combustion will balance, so that no undue wear and tear of the pistons and cylinders will result from the forces of compression and combustion storm and combustion process.

### BACKGROUND OF THE INVENTION

This invention relates to making the combustion chambers of internal combustion engines in such a way that during the period of compression, and due to it, and during the combustion period, and due to it, a storm effect will be created in the air and gasses, by which a predictable control over the combustion will result in the fuel burning as completely as possible, making the efficiency of the engine as high as possible; and so that the perpendicular pressures and forces due to the tangential forces of compression and combustion will balance, so that no undue wear and tear of the pistons and cylinders will result from the forces of compression and combustion storm and combustion process.

As a personal automobile, I owned a Dodge 1974 Dart Sport that I had bought from Chrysler Canada Ltd. It had a Slant Six gasoline engine, consisting of 6 cylinders in an in line block that slanted about 15 to 20 degrees in relation to the vertical.

At that time, people in the know, such as mechanics and sales representatives, commonly referred to its unique slant design as a means to allow for a lower engine compartment in order to benefit the appearance of the vehicle

As I observed unusually good combustion efficiency I asked Chrysler whether they knew of this peculiarity.

Their Manager of Product and Quality Engineering, S. M. McDowall, answered with a two page letter, dated Jul. 18, 1974, of which a copy is inserted in this Abstract and given the page numbers 4 and 5; thus meant to be a part of it, as it gives witness to the conception of the invention.

The gist of it was that the uniquely high efficiency was not known at all.

It affirms that this engine's efficiency, in this vehicle and at an average vehicle speed of 90 kilometres per hour, was as I had claimed: better than 30 miles to the gallon; in metric about 12.5 kilometres per liter.

People in the know believed this to be an efficiency of 25% higher than of any similar car and engine combination of any other make.

With today's use of fuel injectors and electronic equipment all to improve efficiency it is still comparable. From which we may deduce that the efficiency benefits of the wedge shaped chamber design equals the better efficiency benefits of the injection systems and their electronic accessories combined: about 25%.

My method of collecting data was to record my car's odometer reading at the gas pump, top up the tank to almost overflow, and then calculate its efficiency, and repeating this seamlessly at every tanking. So that after fifteen or twenty times I would be able to compute the average over several months, which could thus be regarded as being as accurate as possible.

Had dynamometers been as readily available as they are today, of course I would have such test figures reported to Chrysler, and they, no doubt, would have responded in like. But, as it is, their letter is the only witness of that I ran road tests, and that these were sound enough for them to be expertly checked out similarly—by road tests and with the best measuring equipment available.

It is only lucky that they graciously shared with me that their findings were the same as mine.

These are the unequivocal facts that are fundamental to the invention here being disclosed.

In general it was believed that the purpose of the slanting was that the tangential forces of compression and combustion were to counter the weight caused forces of the pistons being pushed unduly up against the cylinder walls; thus that it was to eliminate the tendency of higher wear and tear in the direction of the pistons leaning down onto the cylinder walls.

But, in the absence of any other possible explanation available, it was and still is being reasoned in this disclosure that the unusually good efficiency of the Slant Six engine was due to that its combustion chambers were wedge shaped.

As it was not known to even the manufacturer that this slanted engine design had an inherently high combustion efficiency, their letter is an unwitting testament to the fact that the wedge shaped combustion chamber design was not intended to benefit combustion efficiency, but that it was incidental to it, and therefore not so by invention. Which I believe gives strength to my claim that my invention is worthy and unique, as well as that it is purely mine.

The potential of the here disclosed invention is that all internal combustion engines can be devised so that their efficiencies will be similarly much improved thus by 25%. Only the dynamometer will be able to tell with certainty, but at this stage it is reasonable to expect a conservative 15% over all improvement.

This can be realized by designing combustion chambers for internal combustion engines that incorporate the rationale explaining the uniquely high efficiency of the Dodge 1974 Dart Sport Slant Six engine, but so that all forces onto the pistons will be in balance in relation to the centre lines of the pistons. Which is the novelty of the Balanced Storm Combustion Chamber concept.

Using the invention will increase the cost of an engine only a very tiny portion of the economic savings potential it will create. Thus it is reasonable to expect that the granting of the patent will start an industry wide research and development effort, that will improve the efficiencies of all makes of internal combustion engines.

Even if this optimistic view would be justified for only one fifth of the possible 25% mentioned, it would still mean a 5% beneficial impact world wide, thus still be of immense dimensions.

But of far greater importance to all of society will be its parallel reductions in air pollutions. Which may well surpass the Kyoto Protocol requirements for all of Canada; certainly in terms of auto caused pollutions.

### BRIEF DESCRIPTION OF THE DRAWINGS

FIG. 1 is a drop of fuel,

FIG. 2 is a visualization of gasification and mixing,

FIG. 3 is a time line of stages of combustion preparation,

FIG. 4 shows the stages in a crank circle,

FIG. 5 is a pressure-volume diagram corresponding to crank cycle,

FIG. 6 is a standard piston,

FIG. 7 is a top view of the piston of FIG. 6 in a cylinder,

FIG. 8 is a slanted piston,

FIG. 9 is an enlarged view of a vector diagram that appears in FIG. 8,

FIG. 10 is a top-down view of piston of FIG. 8 in a cylinder,

FIG. 11 is the concave cavity version of the piston,

FIG. 12 is a top view of the piston of FIG. 11 in a cylinder,

FIG. 13 is a concave cavity version of the piston,

FIG. 14 is a top-down view of the piston of FIG. 13 in a cylinder,

FIG. 15 is the cylinder head of FIG. 13,

FIG. 16 is bottom view of the cylinder head of FIG. 15,

FIG. 17 is a concave cavity version of the piston in combination with a concave cavity version of the cylinder head,

FIG. 18 is a top-down view of piston of FIG. 17 in a cylinder,

FIG. 19 is the cylinder bead of FIG. 17,

FIG. 20 is a bottom view of the cylinder head of FIG. 19,

FIG. 21 is a concave version of the piston in combination with a concave version of the cylinder head,

FIG. 22 is a top-down view of piston of FIG. 21 in a cylinder,

FIG. 23 is the cylinder head of FIG. 21,

FIG. 24 is a bottom view of the cylinder head of FIG. 23,

FIG. 25 is a grooved version of the piston head, and

FIG. 26 is a top-down view of piston of FIG. 25 in a cylinder

### DETAILED DESCRIPTION OF THE DRAWINGS AND PREFERRED EMBODIMENTS

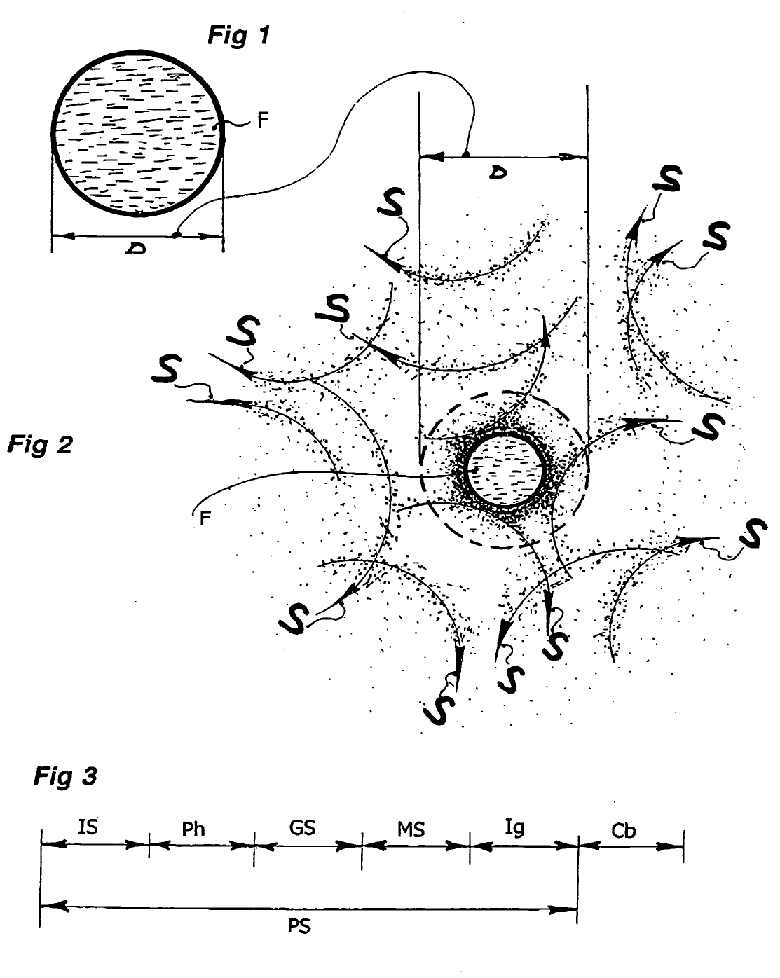

FIG. 1 shows a drop of fuel F, either created by the well-known means of carburetion or by the well-known means injection. As a fuel cannot burn which is its atoms combining with atoms of oxygen the fuel drop, no matter how small, must be made to gasify; which depends on the fuel being heated up first, so that gasification will result.

Part of the invention is to create a storm consisting of rapidly turning whirls, attempting to perfect the mixing so that this period will take as short as possible, yet be complete in time for the ignition, followed by the combustion.

In FIG. 2 the arrow ended line D indicates the diameter of the fuel droplet F. Thus, at the moment that is captured in FIG. 2, the drop of fuel has already more than half gasified, and the swirls of air in the storm S are mixing with the hot compressed air.

The stippling indicates the fuel atoms swirling around, each trying to find its oxygen partner, in order to be wedded, causing the combustion,

FIG. 3 is a time line, without attempting to be to scale, in which the period IS indicates the carburetion or injection stage, of which the drop of fuel in FIG. 1 is the result; Ph indicates the preheating stage; GS indicates the gasification stage in preparation for the mixing stage MS.

The mixing stage is represented ill FIG. 2 by the curved arrows S. The ignition stage Ig, combustion stage Cb are also indicated.

The stages starting from the injection stage IS and proceeding to the ignition stage Ig comprise the preparatory stage PS.

As the experts at Chrysler were not aware of the effect that their wedge shaped combustion chamber design had on efficiency, so nobody knows the accurate time values of each stage. Therefore, at this moment of writing, it is safe to say that nobody in the world is capable, as yet, to predict what will happen, and when, and what the outcome will be, due to a certain combustion chamber design.

Only experimentation can develop the insight of what can and cannot be done in desinging combustion chambers that will have the predictable characteristics one aims for of the highest feasible efficiency and perfect piston balance. The reason for this is that the preparatory time in total, indicated by line 7, is unimaginably short. Even taking all stages together, it is generally accepted that all this takes place in as short a period of time as is equal to 10 crank circle degrees at an average road speed. Thus the time it takes, in most engines, for the crank to travel 10 degrees, with the engine running at about 2400 RPM is the period available for the total of the 6 stages mentioned. In that average situation, 1 RPM takes place in 60/2400=1/40th of a second.

And, in terms of time, 10 degrees being equal to 1/36th of the crank circle, all of the processes named will be completed in 1/36th of 1/40th of a second.

Which is an astounding 0.0006944 second, shorter than one thousandth of a second.

Therefore, it is not surprising that there is a field of automotive fuel efficiency yet to be explored. This field of study has become available only because the dynamometer has become a common tool. Today, anyone with a lathe and a milling machine can make most changes that are disclosed in the drawings numbered herein included, and have the results of the changes determined in an hour or less by using a dynamometer that is typically available at a neighbourhood garage.

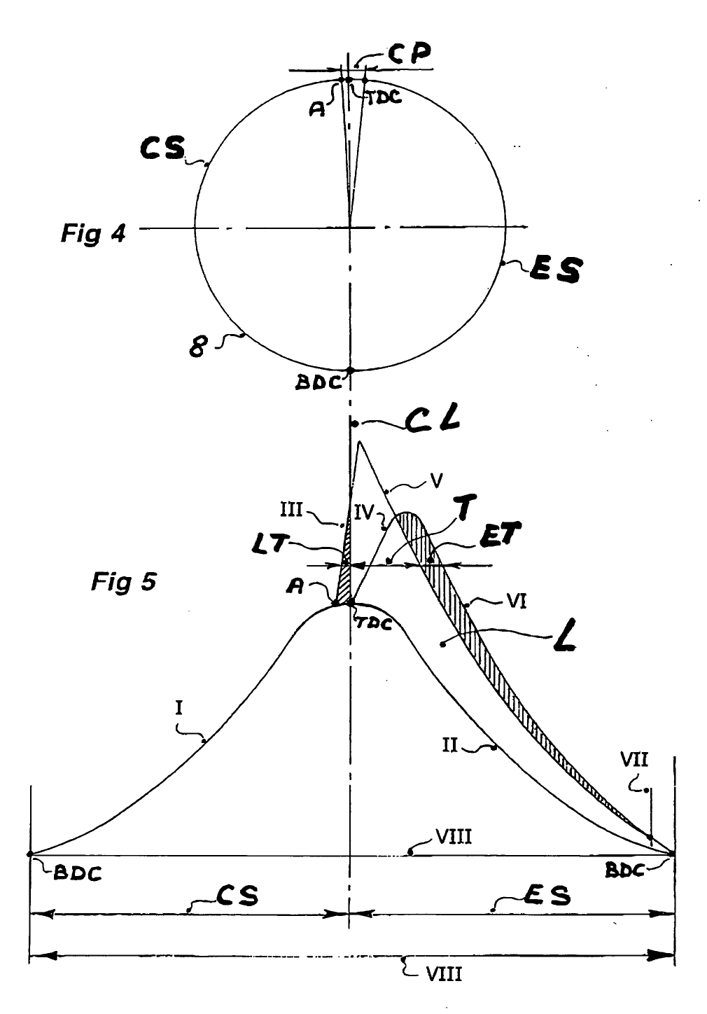

The circular diagram shown in FIG. 4 demonstrates the stages in a typical crank cycle. When the crank is at the bottom dead center BDC, the piston is in the bottom position. With the piston traveling upwards, the crank travels along half of the crank circle 8 and the piston is in the compression stroke CS. The ignition occurs at the point of advance A, just before the crank reaches the top dead centre TDC. A this point, all of the preparatory stages have occurred according to the design of the combustion chamber and from the subsequent stage, the expansion stroke ES (or power stroke, or labour stroke) occurs without the need for further control.

From the top dead center TDC, the piston is on the power stroke and the crank follows the expansion stroke ES portion of the crank cycle CS, being the power stroke when the calories of the combustion are being transformed into crank labour calories, or horse power.

FIG. 5 represents a 360-degree pressure-volume diagram. The vertical axis shows the pressure in the cylinder, and the horizontal axis indicates the crank travel positions, in accordance with FIG. 4, relating to the pressures.

In FIG. 5, starting from the bottom dead center BDC at the far left of the horizontal axis, the line I describes the pressure volume relationship, when the piston travels upwards within the cylinder, indicating the pressure in the cylinder at comparable locations of the piston. Near the top, at the point of advance A, ignition takes place. Here all the stages of fuel preparation for combustion PS according to FIG. 3, have already taken place in the incredibly short period of less than one thousandth of a second before it. What one wishes the combustion to be must have been prepared for and done before the point of advance A in that unimaginably short portion of a second and could only have been so determined by the combustion chamber design.

It is clear from the line III, which is representative of the pressure in the cylinder due to the combustion taking place, goes up before the top dead center TDC is reached by the upwards traveling piston. The lost torque LT is the torque before that is generated before the top dead center TDC is reached. The line T is the positive torque that transfers labour to the crank. The lost torque LT in the hatched area, enclosed by the centre line CL and line III, is lost energy, being the torque multiplied by piston force. It is only a little, but it is to be mentioned here, as it is a waste avoided by the invention. The line II is the pressure volume relationship during the expansion stroke that would be observed if combustion did not occur. Thus, the area between the line II and line V, which shows the pressure volume relationship after combustion takes place L represents the work created by the combustion. At point VII on the expansion line V the exhaust valve opens. Or, in the event of a 2-cycle engine, it is where the exhaust port connects with the cylinder space. The invention aims to create the situation illustrated by line IV, that goes up from the top dead center TDC, thus avoiding the lost torque LT. As the proper combustion chamber design prepares the fuel as complete as we want it to be, the ignition can be allowed to start later in the crank cycle CL, generating lines IV and VI.

The purpose of the invention is to design a combustion chamber causing a storm effect that allows for a later yet complete combustion, so it should be possible that more work will be extracted, by learning from the efficiency benefit of the wedge-shaped design, without having the disadvantage of the undue wear and tear that calls for having to place the engine in a slanted position.

This graph of FIG. 5 is, of course, only a means to convey this concept. And as the design possibilities can only be determined by experimentation, only time will tell what the opportunities will be. But it is for certain that the Slant Six Dodge 1974 engine had a superior fuel efficiency; of as much as 25%. And there was no readily seen reason for this other than that it had a wedge shaped combustion chamber design that caused a combustion storm. Please note the combustion character of engines common now, as seen by line III going up sharply and just as sharply dropping down in the expansion line V. This is typical of the explosion process.

With this invention, what we should strive for is line IV, starting at the top dead center TDC, and slower going over into line B, which is typical of the Diesel process. On the line indicating the torques, from the centre line CL to line VI, we first see the line T, for torque; next to it is, up to line VI, the extra torque ET portion. Conceptually, it is the extra work that is due to the improved combustion chamber design. The torque will be stronger than of the present engines, as the combustion can be allowed to take place longer past the top dead center TDC. And as we know from the Slant Six experience, that a combustion storm can increase an engine's efficiency by 25%, that increase in energy being extracted from the same calories in the fuel available is presented in this graph by die hatched area ET between expansion lines V and VI.

Not only is it reasonable to expect to see this improved combustion, but also that we achieve that typical Diesel character, meaning that more of the work is available later, thus with a stronger torque; meaning a stronger lugging power; further meaning that a smaller engine will be able to do the same work as a larger one can; which means higher efficiency.

It is the purpose of this invention to find the design laws that make most, if not all, of that higher combustion benefit of 25% possible, without having to slant the engine's position, in order to overcome, or counter, its disadvantage of undue wear and tear of pistons and cylinders, due to the combustion chamber design making the benefits possible. Hence the invention's concept of a combustion storm, but with all forces, that work perpendicularly on the piston, being in balance.

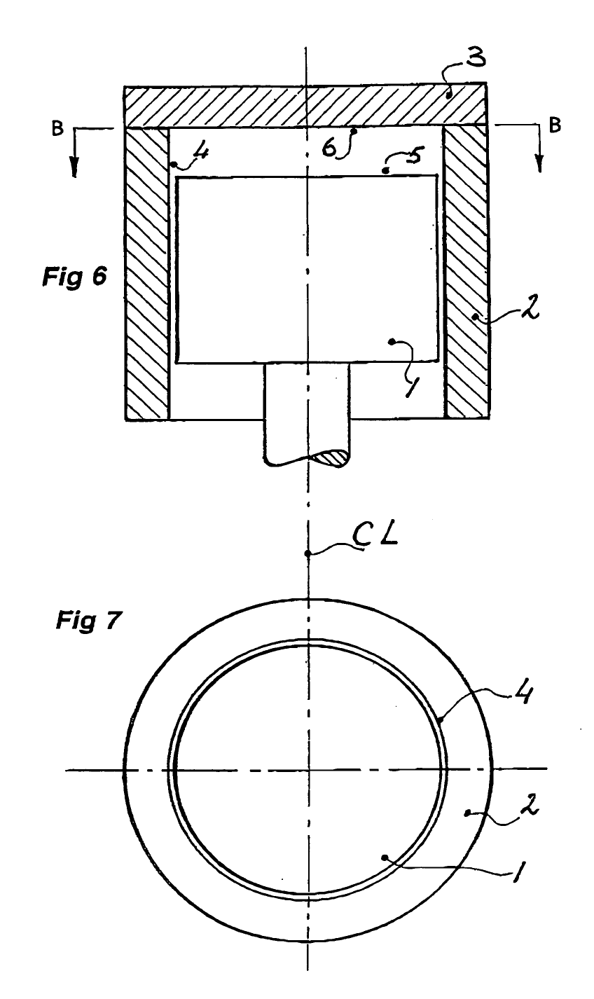

Legend for FIG. 6;

v number 1 marks the piston

v number 2 marks the cylinder

v number 3 marks the cylinder head

v number 4 marks the cylinder wall

v number 5 marks the piston's top

v number 6 marks the chamber wall that's part of the cylinder head

For easy and faster reading, as well as clarity and ready perception, engine parts that have nothing to do with the present invention such as valves, piston rings, cooling spaces, etc., have been left out of the drawings. Also, proportions are in conceptual format, in order to facilitate clear and easy understanding of what is meant, free from all that is redundant in terms of the concept being conveyed.

FIG. 6 shows the concept of a common piston 1 for an internal combustion engine. Typically, it has a flat top 5, that is perpendicular to the piston 1 its side, thus so to the cylinder wall 4. And the cylinder head 3 has also a flat surface 6 that is perpendicular to the centre line CL and parallel to the top surface 5 of the piston 1.

FIG. 7 shows the top view of FIG. 6, as seen from the line AA,

FIG. 8 shows the concept of the wedge shaped combustion chamber, as was applied to the Slant Six Dodge internal combustion engine. It is not redundant to once more emphasize that, for clarity, the dimensions and proportions are conceptual only. For instance, the thick side of the wedge W of the combustion chamber CC, at the left, and the thin side N, at the right are in reality measured in millimeters. The vector diagram inside the drawing of cylinder 2a and piston 1a, the vector P represents the pressure of the gasses onto the piston head 5a. By using this well known method of a vector diagram, it is shown that this pressure P divides into the tangent vertical force V and the horizontal tangent force H. And it shows that it is the horizontal tangent H that pushes the piston 1a up against the cylinder wall 4a, causing undue wear and tear. Which, it was said, was the reason for the uniquely slanted mounting position to counter this force H.

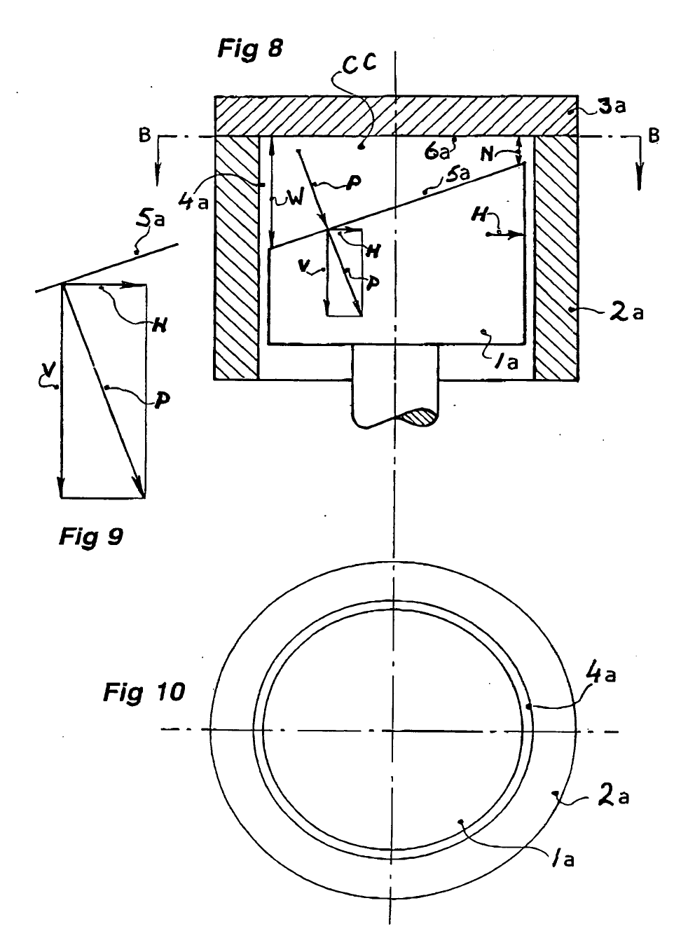

FIG. 9 is this vector diagram enlarged, again for no other reason than clarity.

It is simply logical, when the piston compresses the air during the compression stroke, that the air will flow from the narrow portion N of the combustion chamber CC towards the wider space W, and so will create a storm; much like the operation of bellows to blow air into a fire. As there was no other reason thinkable for it, this must have been the cause of the much increased combustion efficiency of the Slant Six engine. And trying to understand that reason for it gave birth to the invention being disclosed here.

FIG. 10 is the top view of FIG. 8, as seen from the line AA.

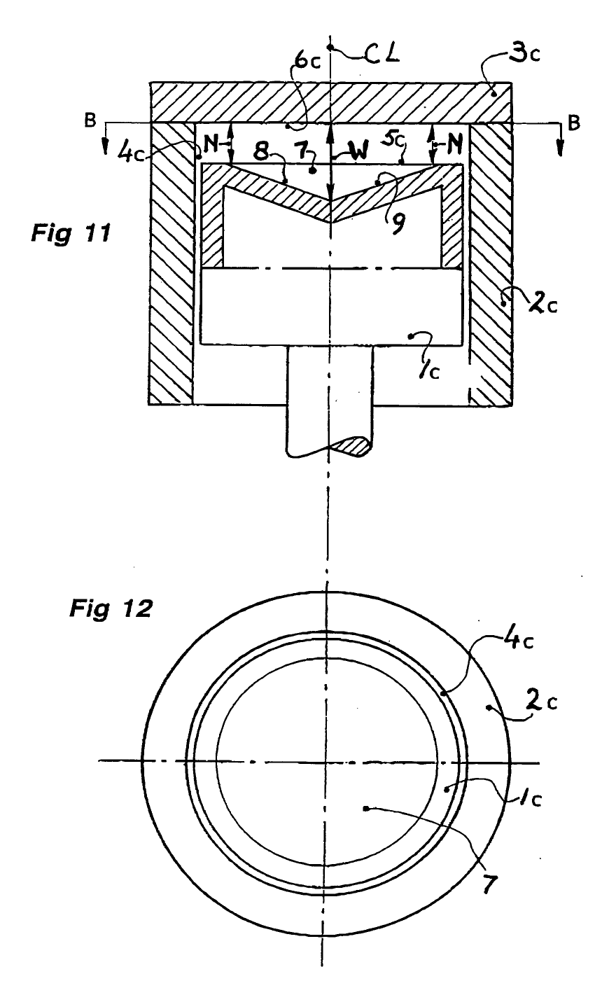

FIG. 11 shows the piston 1c with a concave conical cavity 7. As the shapes and dimensions of the sides 8 on the left of the centre line CL and 9 on the right of it are identical, that due to this, when the forces simultaneously react upon them, due to the compression taking place, and during the combustion thereafter, that they cancel each other out perpendicularly, Which answers one half of the purpose of the invention: That we create a balanced combustion process, meaning that the combustion storm won't cause the piston 1c to unduly press against the cylinder wall 4c. The other half of the invention the combustion storm is of course caused by that the dimensions N are smaller than dimension W is. The swirling storm of the air, created by the compression, and by the further pressure increases due to the gasses of combustion multiplying, cause the flows to collide forcefully in the centre of the concave space 7.

FIG. 12 is the top view of FIG. 11.

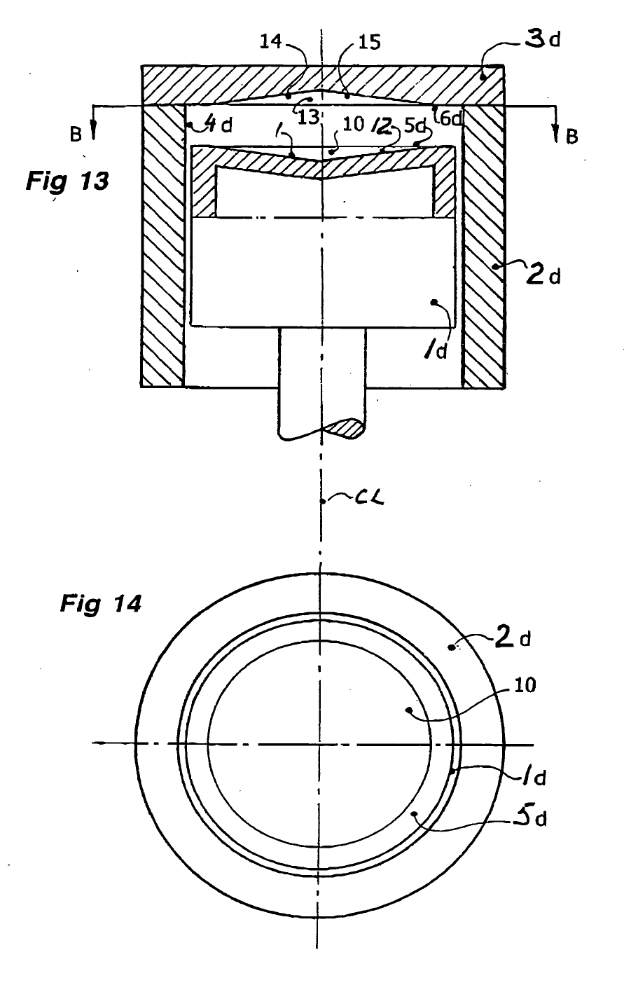

FIG. 13 shows a conical concave space 10, similar to what is shown in FIG. 11, in the top surface 5d of the piston 1d, with the left side 11 being the same in size and form as the right side 12. A concave cylindrical space 8 has been made in the surface 6d of the cylinder head 3d that is similar in dimensions and form as applied to the top 5d of the piston 1d. The storm's swirls in the top space 13 and the bottom space 10 will collide with extra force in the centre, thus having a specific result.

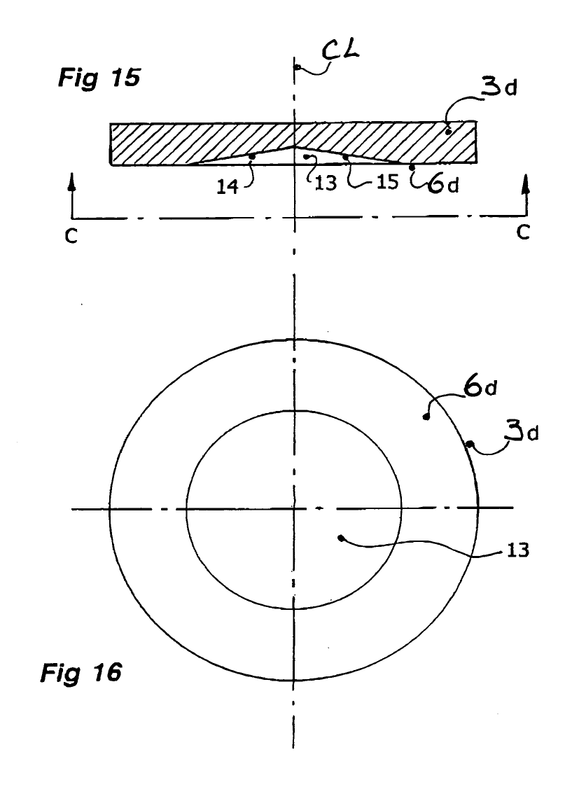

FIG. 14 is the top view of piston 1d in the cylinder 2d, as seen from the line BB down. FIG. 15 is the sectional view of the cylinder head 3d of FIG. 13, repeated to show that the concave space 13 is symmetrically cylindrical. FIG. 16 is the bottom view as seen from the line CC.

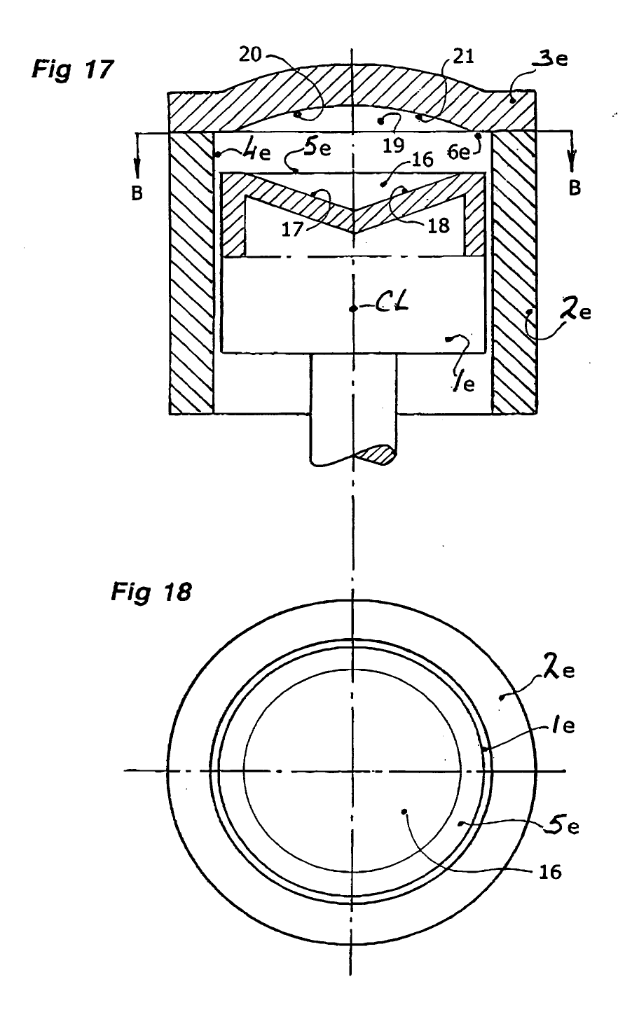

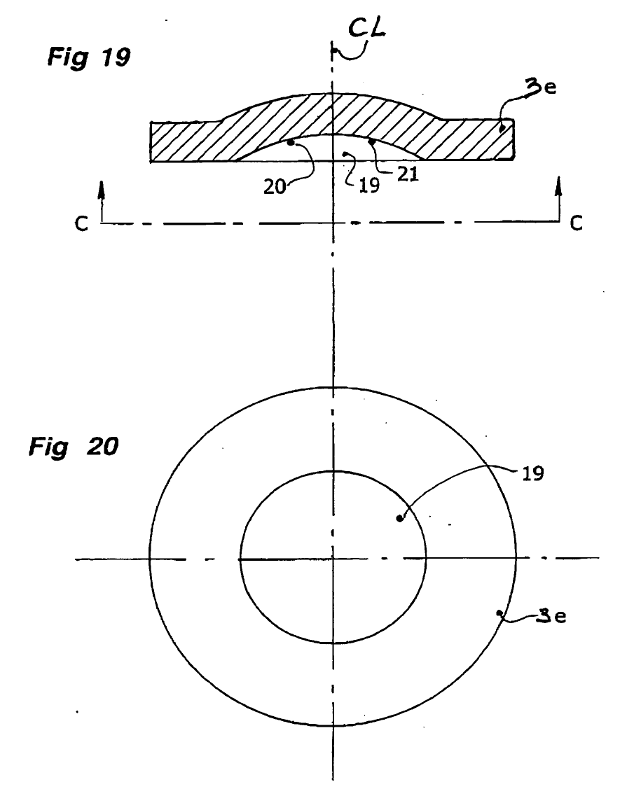

FIG. 17 shows a combination of the cylindrical concave form 19 in the cylinder head 3e, and the pointed conically shaped concave space 16 in the top surface 5e of the piston 1e. As with the concept shown with FIG. 13, here the storm its forces onto the piston 1e, that are directed by the cavity 16 in the piston 1e its top surface 5e balance each other out, due to that the left side 17 is the same in dimension and form as is the right side 18 of the cavity 16. And the same reasoning applies to the cavity 19 in the surface 6e of the cylinder head 3e as the surface 20, left of the centre line CL, and the surface 21, right of the centre line CL, are symmetrical, the perpendicular forces directed by them cancel each other out. But the cavity 19 in the head 3c is different in shape from the cavity 16 in the piston 1e its top 5e, thus the resulting difference may be of interest. Purpose number one of the invention has been fulfilled that of the combustion storm, which, true to the example of the Slant Six engine, is expected to create a high combustion efficiency. And purpose number two of the invention has been addressed, in that the result of the perpendicularly directed forces on the piston 1, during compression and combustion, will balance each other out, so that we can have the combustion efficiencies of the Slant Six, without having to slant the engine. FIG. 18 shows the top view of FIG. 17, as seen from the line BB down. FIG. 19 shows the cylinder head 3e, as in FIG. 17.

FIG. 20 is the bottom view of the cylinder head 3e, as seen from line CC up.

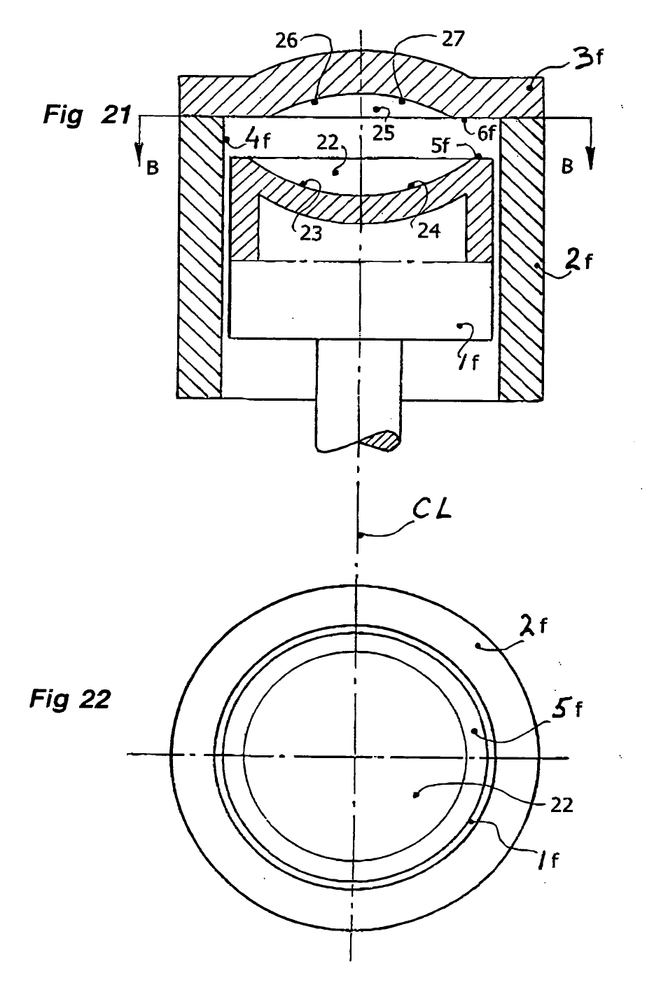

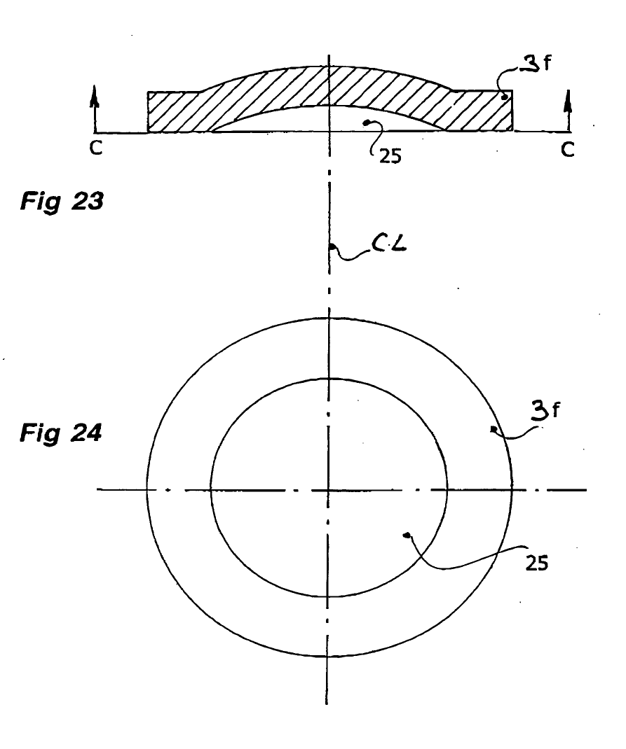

FIG. 21 shows yet one more embodiment. In the cylinder head 3f the concave space 25, the left side 26 and the right side 27 are the same in form and dimension. And in the piston if top surface 5f the concave space 22 is symmetrical as well, as the right side 24 is the same in form and dimension as is the left side 23. Which, as discussed with the example shown by FIG. 17, will cause the perpendicularly directed forces from the air during compression and from the gas mass during combustion, which act on the piston 1 perpendicularly, to cancel each other out. And so, again, both purposes of the invention the highest combustion efficiencies and internal combustion chamber balances are being realized. FIG. 22 is the top view of the cylinder 2f, with the piston if seen in it, and the cylinder head 3f removed. FIG. 23 shows the cylinder head 3f, as in FIG. 21. FIG. 24 is the bottom view of FIG. 23.

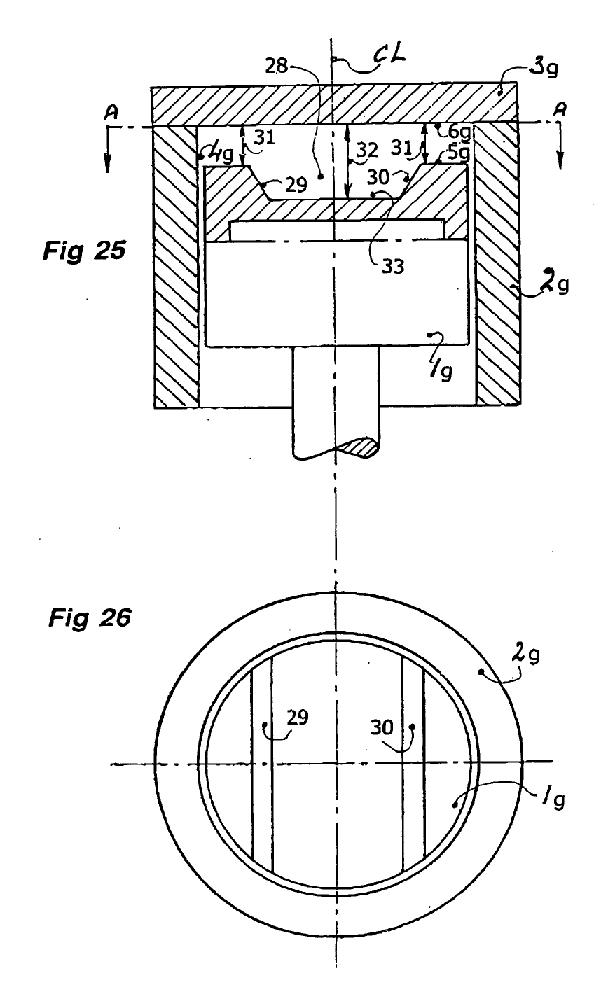

FIG. 25 shows a slotted version of the cavity 28 in the surface 5g of the piston head 1g. The same reasoning concerning combustion efficiency and perpendicular balance apply as with the foregoing suggestions to realize the concept. The vertical dimensions 31 between the piston 1g its top 5g and the cylinder head 3g its surface 6g being smaller than the distance 32 between cylinder head 3g its surface 6g and the groove its bottom surface 33, will cause the air, during compression, and the gasses, during the combustion, to flow faster towards the centre line CL, causing the storm and collide in the centre line area. Further, since the left side 29 and the right side 30 in the groove 28, in the top surface 5g of the piston 1g, are the same in dimension and form, the resulting perpendicularly aimed forces onto the piston 1g will cancel each other out, thus creating the balanced combustion chamber that the invention promises. FIG. 26 shows the top view of FIG. 25, from the line BB downward.

I claim:

1. A combustion chamber for an internal combustion engine comprising a cylinder having a cylinder head at one end, a piston located within the cylinder that reciprocates along a longitudinal axis of the cylinder, a compression surface of the piston facing the cylinder head being symmetrical and having an axis of symmetry about the longitudinal axis of the cylinder and a concave depression along the axis of symmetry such that a peripheral edge of the piston represents an apex of the compression surface,
whereby compression of a fuel mixture within the combustion chamber by the shortening of the linear distance between the piston and the cylinder head causes a combustion storm to occur, and the symmetry of the compression surface causes the forces acting perpendicular to the direction of piston movement within the cylinder due to the combustion of the fuel mixture will be substantially cancelled out, providing a balanced combustion process in which forces acting on the piston are directed along the longitudinal axis of the cylinder.

2. The combustion chamber of claim 1 in which the compression surface forms a wedge-shaped depression along its axis of symmetry in which the short side of the wedge is at the centre of the piston surface.

3. The combustion chamber of claim 2 in which the surface of the cylinder head forms a conical concave space.

4. The combustion chamber of claim 1 in which the piston surface forms a rounded depression along its axis of symmetry.

5. The combustion chamber of claim 4 in which the piston surface forms a spherical concave depression along its axis of symmetry.

6. The combustion chamber of claim 1 in which the piston surface forms a slotted depression along its axis of symmetry.
